(19) United States
(12) Patent Application Publication
(10) Pub. No.: US 2010/0143653 A1
(43) Pub. Date: Jun. 10, 2010

(54) PROCESS OF FORMING A POLYMERIC PRODUCT CONTAINING CREMATION ASHES

(75) Inventors: Nicholas George Cranham, Nottingham (GB); Victor Ralph Vaughan, Derbyshire (GB)

Correspondence Address: PATENTTM.US, P. O. BOX 82788, PORTLAND, OR, 97282-0788, US

(73) Assignee: CARBON FIBRE DEVELOPMENTS LIMITED, Nottingham (GB)

(21) Appl. No.: 12/517,537

(22) PCT Filed: Dec. 14, 2007
(86) PCT No.: PCT/GB2007/004802

§ 371 Date: Jan. 25, 2010

(30) Foreign Application Priority Data
Dec. 18, 2006 (GB) 0625190.4

(51) Int. Cl. C08L 99/00; B32B 3/10

(52) U.S. Cl. 428/156; 524/78

(57) ABSTRACT

The present invention relates to a method of forming a cremation ashes-containing polymer product, comprising the steps of: (i) providing cremation ashes, (ii) washing the cremation ashes in a medium, and (iii) combining the washed ashes with a polymerisable agent and/or polymer melt to form a cremation ashes-containing polymer product. Polymer products obtained by the method, or articles made from them, provide a unique and permanent keepsake of a deceased person or pet.

The present invention relates to methods of embedding or encapsulating cremation ashes in a polymer, so as to obtain a cremation ashes-containing polymer product, and of making articles comprising the polymer product.

It is comforting for relatives of a deceased person, or owners of a deceased pet, to have some form of memento or keepsake of their loved one. This is often done by keeping the cremated remains or ashes of the deceased person or pet in an urn.

Also, it is known that carbon may be extracted from cremation ashes and subjected to a process including high temperature and pressure to form diamond, which can be faceted and mounted to form jewelry. Alternatively, cremation ashes may be placed in a cavity formed in an article, such as a keepsake urn. Small keepsake urns can be made into items of jewelry, such as pendants or lockets. However, the art has hitherto failed to provide keepsake items comprising cremation ashes encapsulated in a polymer, or methods of making such items.

The present invention seeks to improve on this prior art. By encapsulating cremation ashes in a polymer, the invention provides a product which is, or can be formed into, a unique and permanent keepsake of a deceased person or pet.

The listing or discussion of a prior-published document in this specification should not necessarily be taken as an acknowledgement that the document is part of the state of the art or is common general knowledge.

A first aspect of the invention provides a method of forming a crematorium ashes-containing polymer product, comprising the steps of:
(i) providing cremation ashes,
(ii) washing the cremation ashes in a medium, and
(iii) combining the washed ashes with a polymerisable agent and/or a polymer melt to form a cremation ashes-containing polymer product.

By “cremation ashes” we mean the cremated remains of a body. Cremation is typically carried out by burning a body at a very high temperature in a furnace, such as a cremation furnace. Generally, a body is placed in a container for cremation, such as a cardboard box or wooden casket. Caskets may be of solid wood or particle board, for example. Typically, soft tissues and body organs are vaporised during cremation, and all that remains after cremation are bone fragments. In general, jewelry may not be removed from a human before cremation, and so the cremated remains may contain components derived from jewelry. Other components present within cremated remains may arise from, for example, dental fillings, surgical implants, or the casket. Such components may be removed from the cremated remains. Optionally, the remains may be pulverised, for example using a cremulator.

According to the method of the first aspect of the invention, cremation ashes are formed into a cremation ashes-containing polymer product. Where a polymerisable agent is used in the method to form the polymer product, virtually any polymer may be made, including thermoplastic polymers, thermosetting polymers and elastomers. Preferably, the polymer is an epoxy, a polyester, a polyalkene, polyvinylchloride, an acrylic, a polyurethane or a polycarbonate polymer. Where a polymer melt is used in the method to form a polymer product, the polymer is a thermoplastic polymer, preferably a polyester, polyalkene, polyvinylchloride, acrylic, polyurethane or a polycarbonate polymer. A polymer melt is prepared by heating a thermoplastic polymer until it melts.

It will be apparent to those skilled in this art that, to obtain any given type of polymer by a chemical process, appropriate polymerisable agents are required. Suitable polymerisable agents may include epoxy prepolymers, diesters, diols, alkenes, substituted alkenes, acrylate monomers, or combinations thereof. For example, epoxy prepolymers are required to form epoxy. Diesters and diols are required to form polyesters. Alkenes are required to form polyalkanes. Polymers may also be made from substituted alkenes. For example, vinyl chloride is a substituted alkene from which polyvinyl chloride may be made. Acrylate monomers suitable for forming acrylics include acrylic acid, butyl acrylate, 2-ethylhexyl acrylate, methyl acrylate, ethyl acrylate, acrylonitrile, n-butanol, methyl methacrylate, and tri methylol propane triacrylate (TMPTA). Diisocyanates and polyols are required to form polyurethanes. Typical polyols are polyethylene glycol and polyester polyol. Although polycarbonates can be made from a variety of polymerisable agents; a common type of polycarbonate plastic is made from Bisphenol A and carbonyl dichloride. A polymer resins which can undergo a further polymerisation or crosslinking reaction to form a polymer may also be used as polymerisable agent. For example, an epoxy or a polyester resin may be used.

An appropriate quantity of cremation ashes is combined with the polymerisable agent and/or polymer melt, depending on the aesthetic effect desired, and the viscosity required, for example, where the mixture is to be cast or placed into a mould. Typically, the ratio of ashes to polymerisable agent is about 2:1 (w/w). It will be appreciated that, to make a small item, it can be useful to prepare a larger than required mix to reduce inaccuracy of mix ratios and hence obtain consist results.

Polymerisable agents may be formed into polymer products according to the method of the first aspect of the invention simply by combining the washed ashes with the polymerisable agent and allowing polymerisation to occur. The combination step may be performed mechanically, or by hand-mixing. Polymerisation may be promoted by varying the temperature, for example by heating, or by exposing to other suitable conditions such as electromagnetic radiation. Additional agents may also be required to promote polymerisation. The skilled person in this art appreciates that ovens or incubators or other equipment may provide suitable conditions for polymerisation to occur.

It is preferred that the polymer is transparent. This allows the cremated ashes to remain visible when formed into the polymer product.

In the method of the first aspect of the invention, the cremation ashes are washed in a medium. Cremation ashes naturally contain lime, which is composed of calcium oxide, calcium hydroxide and calcium carbonate. It is believed that washing the cremation ashes in a medium reduces the lime content and allows cremation ashes to be formed into a polymer product comprising virtually any polymer. Without wishing to be bound by theory, the inventors believe that removal of the lime content can improve the formation of polymer from the polymerisable agent combined with the ashes. Where the polymer product is formed from a polymer melt combined with the ashes, removal of the lime content can also improve formation of the polymer product. Removal of lime content may also improve the long-term chemical stability of the polymer product. Washing the cremation ashes also enables fine dust particles to be removed, which can improve the aesthetic appearance of the polymer product.

Preferably, the medium in which the cremation ashes are washed in is an aqueous medium, more preferably, water. Suitably, ashes may be washed by rinsing and agitating in warm water.

Preferably, according to the method of the first aspect of the invention, the washed ashes and the polymerisable agent are combined with an additional agent suitable to promote polymerisation of the polymerisable agent. Suitably, the additional agent comprises a catalyst and/or a comonomer. It will be apparent to one of skill in this art that the selection of an appropriate additional agent depends on the identity of the polymerisable agent. In some circumstances, a catalyst is required to catalyse polymerisation. Where the polymer is formed by the polymerisation of more than one type of monomer, and the polymerisable agent does not comprise all types of monomer, the additional agent contains the monomer type or types missing from the polymerisable agent. Alternatively, the polymerisable agent may comprise all types of monomer required to form the polymer. For example, where the polymer is a polyester, the polymerisable agent may comprise a diol and the additional agent may comprise a diester, or vice versa. A polyester may also be formed by further polymerisation of a polyester resin. In this case, a suitable additional agent is a catalyst such as an organic peroxide, for example methyl ethyl ketone peroxide. The quantity of additional agent, such as catalyst or comonomer, required for a given quantity of the polymerisable agent to form a polymer is within the knowledge of the person of skill in this art. In any case, suitable quantities can be determined empirically. It will be appreciated that, in many cases, increasing the quantity of catalyst increases the rate of polymerisation.

Preferably, in the method of the first aspect of the invention, the washed ashes are dried prior to combining with the polymerisable agent and/or polymer melt to form the cremation ashes-containing polymer product. Conveniently, drying may be performed by spreading the ashes on a surface exposed to air, for example heating in an oven, particularly, a ventilated oven.

The method of the first aspect of the invention may further comprise the step of combining the washed ashes and the polymerisable agent and/or polymer melt with a visual effect agent, such as a filler and/or a colourant. The skilled person in this art will understand that, as well as being chosen for its visual effect, a suitable visual effect agent must also be compatible with the polymerisation agent. In other words, it must not prevent polymerisation from occurring. Suitable visual effect agents can be obtained from Bentley Chemicals Ltd, Rowland Way, Hoo Farm Industrial Estate, Kidderminster, Worcester, DY11 7RA, United Kingdom.

The method of the first aspect of the invention is particularly intended to be applied to cremation ashes formed by incineration of the posthumous remains of a living being. Suitably, the living being is an animal, such as a mammal, bird or reptile. Appropriately, the animal is a pet. Alternatively, the living being is a human.

The method of the first aspect of the invention preferably further comprises the step of placing the washed ashes and the polymerisable agent and/or polymer melt in a mould until formation of the polymer product is substantially complete. In the case where a polymerisable agent is used, the formation of the polymer product is substantially complete when polymerisation of the polymerisable agent is substantially complete. In the case were a polymer melt is used, the formation of the polymer product is substantially complete when the polymer melt has cooled sufficiently to harden. Typically, the mould may be in the shape of a jewel, statue, plaque, casket or urn. The person of skill in this art recognises that the mould must be compatible with the polymerisable agent such that, after polymerisation, the polymer product can be removed from the mould. Suitably, a silicone rubber mould may be used.

Where the polymer product is formed so as to contain an open cavity, the cavity may be back-filled with additional ashes and polymerisable agent and/or polymer melt. Preferably, the entire interior of the original polymer product is filled. The ashes in the original polymer product may be graded to a be in a particular size range for aesthetic effect. The ashes to be back-filled into the cavity of the original polymer product need not be so graded. This can allow larger ashes to be used without affecting the final appearance of the back-filled polymer product. It is particularly appropriate to cast the original polymer product in a mould to allow a cavity to be formed for back-filling. If a cavity of sufficient size is created, it may be possible to use all of the ashes of the cremated animal or human in the polymer product. Suitably, the polymer product may be cast in the shape of an urn, a casket or a statue.

The method of the first aspect of the invention may further comprise the step of sieving the ashes prior to combining the washed ashes with the polymerisable agent and/or polymer melt to form the cremation ashes-containing polymer product. Sieving the ashes allows ashes within a particular size range to be selected appropriate for the desired polymer product. Larger polymer products, such as those in the shape of urns or statues may typically utilise ashes having dimensions in the range of about 0.2 mm to about 10 mm. Preferably, small polymer products, such as those suitable to be made into jewelry, would typically utilise small ashes, for example ashes having dimensions in the range of about 0.2 mm to about 5 mm, more preferably from about 0.25 mm to about 4 mm. Suitable dimensions of the particles of sieved ashes may be about 10 mm, 9 mm, 8 mm, 7 mm, 6 mm, 5 mm, 4 mm, 3 mm, 2 mm, 1 mm, 0.8 mm, 0.6 mm, 0.4 mm, 0.3 mm, 0.25 mm or 0.2 mm. Typically, ashes are first sieved through a sieve with a larger mesh size, to remove the larger ashes. The smaller ashes are then sieved through a sieve with a smaller mesh size, to remove the smallest ashes. In this way, ashes having dimensions between the larger and smaller mesh sizes are obtained. Alternatively, the ashes may first be sieved through a sieve with a smaller mesh size, and then sieved through a sieve with a larger mesh size. By sieving with sieves of appropriate mesh size, the ashes can be graded according to their dimensions as required.

A second aspect of the invention provides a method of making an article comprising processing and/or mounting the polymer product formed by the method of the first aspect of the invention.

Processing may alter the shape or appearance of the polymer product. Typically, processing may comprise cutting, engraving and/or polishing the polymer product. Methods of processing polymers are known in the art. The article formed by the method of the second aspect of the invention may be made by mounting the polymer product on a solid object. For example, when the article is an item of jewelry, the polymer product may be mounted on a fixing. Typically, the fixing is made of a metal, such as a precious metal, for example silver or gold, or other metals or alloys known to jewelers for this purpose. The nature of the fixing will depend on the nature of the item of jewelry to be made. Suitably, the polymer product can be formed and/or processed in the shape of a stone for a pendant. In this case, the fixing will be a pendant back. The polymer product may be glued to the fixing or mechanically fitted into the fixing using methods known in the jewelry arts. Epoxy adhesives may be suitable for this purpose. Other suitable types of jewelry include brooches, lockets, earrings, rings, hatpins and cufflinks.

A third aspect of the invention provides a polymer product obtainable by the method of the first aspect of the invention.

A fourth aspect of the invention provides an article obtainable by the method of the second aspect of the invention.

A fifth aspect of the invention provides a polymer product comprising cremation ashes embedded in a polymer. Cremation ashes are as defined above. Appropriate polymers include those discussed in relation to the first aspect of the invention. Typically, the polymer product is processed and/or mounted as discussed in relation to the first aspect of the invention, such as by cutting, engraving and/or polishing.

### EXAMPLE 1

### Production of a Polyester Casting of 25 mm Diameter for a Pendant

The cremation ashes of an animal were obtained from a pet crematorium and were graded between 4 mm and 0.25 mm by sieving.

100 g of the cremation ashes were washed by agitating and rinsing in water at 30° C. They were then drained of excess water and placed on a flat tray, which was heated in an oven at 100° C. for 30 minutes.

A silicone rubber mould obtained from Bentley Chemicals Ltd (UK) (cat. no. RTV3450) was preheated to 30° C. The mould was in the shape of a half ellipsoid with a circular face having a diameter of 25 mm.

General purpose polyester resin was obtained from Euroresins (UK) Ltd, Cloister Way, Ellesmere Port, CH65 4EL, United Kingdom, acting as agents of DSM Composite Resins AG (cat. no. DSM6061). The catalyst methyl ethyl ketone peroxide was also obtained from Euroresins (UK) Ltd. 20 g of the polyester resin was placed into a mixing cup. 2 g of catalyst was added to the resin and mixed thoroughly. 45 g of the dried ashes were added to the mixing cup and mixed with the polyester resin and catalyst.

The preheated mould was filled with the required amount of the ash/resin mixture using a spatula, and placed in oven at 35° C. for one hour. After confirming that the polymer product was set, it was removed from the mould.

The face of the polymer product was polished using 1200 grit wet and dry paper followed by T-Cut polish, and the polymer product was ready to be set into a pendant fixing mechanically or by gluing its flat back to the fixing with an epoxy adhesive.

1. A method of forming a cremation ashes-containing polymer product, comprising the steps of:
i. providing cremation ashes,
ii. washing the cremation ashes in a medium, and
iii. combining the washed ashes with a polymerisable agent and/or a polymer melt to form a cremation ashes-containing polymer product.

2. The method of claim 1 wherein, where the method comprises combining the washed ashes with a polymerisable agent, the polymerisable agent is selected from an epoxy prepolymer, a diester, a diol, an alkene, a substituted alkene, an acrylate monomer, a diisocyanate, a polyol and combinations thereof, an epoxy resin, a polyester resin, and where the method comprises combining the washed ashes with a polymer melt, the polymer melt is selected from a polyester, polyalkene, polyvinylchloride, an acrylic, polyurethane, a polycarbonate polymer.

3. The method of claim 1 wherein the polymer is selected from an epoxy, a polyester, a polyalkene, polyvinylchloride, an acrylic, a polyurethane, a polycarbonate polymer.

4. (canceled)

5. The method of claim 1 wherein the polymer is transparent.

6. The method of claim 1 wherein the medium is an aqueous medium.

7. (canceled)

8. The method of claim 1 wherein the washed ashes and the polymerisable agent are combined with an additional agent suitable to promote polymerisation of the polymerisable agent.

9. The method of claim 8 wherein the additional agent comprises a catalyst and/or a comonomer.

10. The method of claim 1 comprising the step of drying the washed ashes prior to step (iii), and comprising the step of sieving the ashes prior to step (iii).

11. The method of claim 1 further comprising the step of combining the washed ashes and the polymerisable agent and/or polymer melt with a visual effect agent, the visual effect agent being selected from a filler and a colourant.

12. (canceled)

13. (canceled)

14. The method of claim 1 wherein the cremation ashes are formed by incineration of the posthumous remains of a living being.

15. The method of claim 10 wherein the living being is an animal.

16. (canceled)

17. The method of claim 14 wherein the living being is a human.

18. The method of claim 1 further comprising the step of placing the washed ashes and the polymerisable agent and/or polymer melt in a mould until formation of the polymer product is substantially complete.

19. (canceled)

20. (canceled)

21. A method of making an article comprising processing and/or mounting the polymer product formed by claim 1 on a fixing to form the article, wherein the step of processing the polymer product comprises cutting, engraving and/or polishing the polymer product.

22. (canceled)

23. The method of claim 21 wherein the article is jewelry and the polymer product is mounted on a fixing.

24. A polymer product obtainable by the method of claim 1.

25. An article obtainable by the method of claim 21.

26. A polymer product comprising cremation ashes embedded in a polymer.

27. An article comprising the polymer product of claim 26, which polymer product is processed and/or mounted to form the article.

28. The article of claim 27 wherein the polymer product is processed by cutting, engraving and/or polishing.

29. (canceled)

30. (canceled)

31. (canceled)
